(19) United States
(12) Patent Application Publication
(10) Pub. No.: US 2025/0148895 A1
(43) Pub. Date: May 8, 2025

(54) Traffic Stop Firearm Discharge Detection Device and System

(71) Applicant: MFR Consultants, Inc., Philadelphia, PA (US)

(72) Inventors: Maria Frizelle Roberts, Philadelphia, PA (US); Philip Rhym, Philadelpha, PA (US); Victor Santoro, Sharon Springs, NY (US)

(21) Appl. No.: 18/935,870

(22) Filed: Nov. 4, 2024

Related U.S. Application Data
(60) Provisional application No. 63/596,642, filed on Nov. 7, 2023.

(51) Int. Cl. G08B 21/10; G08B 25/00; G10L 25/51

(52) U.S. Cl. CPC G08B 21/10; G08B 25/00; G10L 25/51

(57) ABSTRACT

An edge device includes a microphone and is configured to detect a static position of the edge device for a first time period and to record audio received by the microphone while the static position remains constant. The device determines whether a target sound is within the audio received by the microphone by analyzing audio and sends an alert when the target sound is determined to be within the audio. The target sound may include a firearm discharge. Additionally, or alternatively, the edge device analyzes the audio for types of decibel levels and echoes inside the audio that track to the firearm discharge. The alert may comprise a package of information that includes a location.

### RELATED APPLICATION

This application claims priority to U.S. Provisional Application No. 63/596,642 filed Nov. 7, 2023, which is incorporated herein by reference in its entirety.

### BACKGROUND

A traffic stop can be dangerous for police officers, particularly with respect to gun violence during the traffic stop. Currently, police officers must rely on witness communication and/or conventional radios and corresponding radio communications when a firearm is discharged to call for additional police support or emergency services. Witness communication can be unreliable and slow. Witness communication requires a witness who is willing to act on behalf of the police officers. Conventional radios and radio communications require active manual use by the police officers, which further requires the police officers to have physical close access to the radios and all human faculties operational.

Generally, there are no technological advances to support police officers during traffic stops when a firearm is discharged. At best, conventional measures to protect police officers include body cameras, which merely record a progress of a traffic stop and provide no immediate support. At worst, if a witness does not act and an office is unable to operate their conventional radio, additional police support or emergency services may never be called or alerted when a firearm is discharged.

A solution is needed to guarantee the safety of a police officer during a traffic stop with respect to gun violence.

### SUMMARY

In one embodiment, an edge device is disclosed that includes a microphone. The edge device is configured to detect a static position of the edge device for a first time period and to record audio received by the microphone while the static position remains constant. The device determines whether a target sound is within the audio received by the microphone by analyzing audio, and sends an alert when the target sound is determined to be within the audio. The target sound may include a firearm discharge. Additionally, or alternatively, the edge device analyzes the audio for types of decibel levels and echoes inside the audio that track to the firearm discharge. The alert may comprise a package of information that includes a location. In a specific embodiment, the alert causes an immediate order of emergency service or dispatch of additional resources.

In another embodiment, a method is disclosed for processing a sound. The method includes detecting a static position of an electronic network device for a first time period and recording audio while the static position remains constant. The recorded audio is analyzed by the electronic network device to determine whether a target sound is present within the recorded audio, and the electronic network device sends an alert when the target sound is determined to be within the recorded audio. The electronic network device, in specific embodiments, is an edge device. The method may further include the electronic network device analyzing the recorded audio for types of decibel levels and echoes inside the audio that track to a firearm discharge. The electronic network device may send an alert that includes a package of information, with that information in specific embodiments including a location. In a specific embodiment, the method includes automatically triggering an immediate order of emergency service or dispatch of additional resources in response to the alert sent by the electronic network device.

In yet another embodiment, an emergency vehicle is disclosed that includes an electronic network device, which may for example be an edge device. The electronic network device includes a microphone and is configured to detect a static position of the emergency vehicle for a first time period. Audio received by the microphone of the electronic network device is recorded while the static position of the emergency vehicle remains constant. The electronic network device determines whether a target sound is within the audio received by the microphone by analyzing the recorded audio, and the alert is sent when the target sound is determined to be within the audio.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 illustrates a method according to one or more embodiments;

FIG. 2 illustrates a system according to one or more embodiments;

FIG. 3 illustrates a method according to one or more embodiments; and

FIG. 4 illustrates a method according to one or more embodiments.

### DETAILED DESCRIPTION

Disclosed is a non-limiting embodiment of a sound detection system in the form of a traffic stop firearm discharge detection system. The traffic stop firearm discharge detection system can be implemented as a computer program product that is necessarily rooted in at least one processor to improve operations of the at least one processor and any computing system or environment including the at least one processor.

According to one or more embodiments, the traffic stop firearm discharge detection system can be a hardware/software platform that resides at least partially in a vehicle (e.g., a municipal vehicle, a police vehicle, or other vehicle) that actively listens for firearm discharges during traffic stops. When a firearm discharge is heard or detected by the hardware/software platform, the hardware/software platform immediately generates alerts identifying, for example, a location of the firearm discharge. The hardware/software platform further enables a user (e.g., a police officer) to verify whether a firearm discharge was heard or detected, so that the alerts can be disregarded.

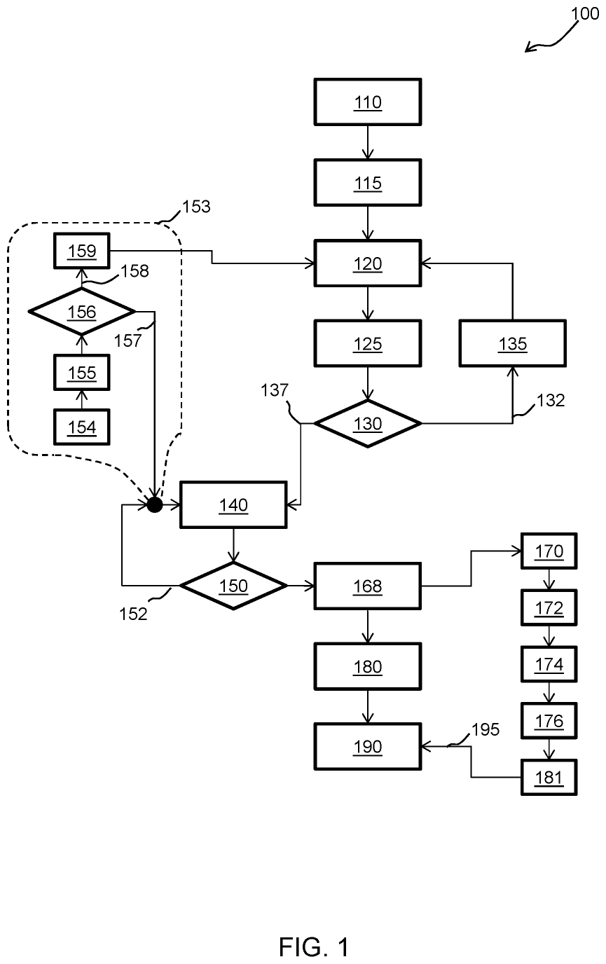

As shown in FIG. 1, a method 100 implemented by the sound detection system (which is an example of the traffic stop firearm discharge detection system) is illustrated according to one or more embodiments. At block 110, the sound detection system receives power. For example, when at least a portion of the sound detection system is installed in a vehicle and the vehicle is turned on, power from the vehicle is provided to that portion of the sound detection system. According to one or more embodiments, the at least a portion of the sound detection system can include an electronic network device in the form of an edge device having at least a location module (e.g., a global positioning system) and a communications system (e.g., communications adapter), and installed in the vehicle. The edge device includes a memory with computer program code (e.g., firmware) stored thereon for causing the edge device to perform operations of the method 100.

At block 115, the sound detection system detects and stores a first location status of a vehicle at a first time. The vehicle can be any municipal vehicle, police vehicle, farm vehicle, recreational vehicle, sport utility vehicle, consumer vehicle, commercial vehicle, water vehicle, air vehicle, or other vehicle. The first time can be a zero (0) instance on a timer respective to the power on. The first time can be an actual or real time of a clock. According to one or more embodiments, the edge device of the sound detection system can perform the operations of block 115 including using the location module (e.g., global positioning system) to determine the first location status as described herein. The first location status can be a location designated by, for example, a longitude and latitude, a global positioning point, a location triangulation, a location coordination, or other location.

At block 120, the sound detection system counts for a first time period. According to one or more embodiments, the edge device of the sound detection system can perform the operations of block 120. The first time period is a configurable amount of time. The first time period is configurable and storable within the edge device. Examples of the first time period include, but are not limited to, five (5) seconds, ten (10) seconds, 15 seconds, 30 seconds, or 60 seconds. Other examples of the first time period include, but are not limited to, a value selected from a range of one (1) second to 3,600 seconds.

At block 125, the sound detection system detects a second location status of the vehicle at a conclusion of the first time period. According to one or more embodiments, the edge device of the sound detection system can perform the operations of block 125. The second location status can be a location designated by, for example, a longitude and latitude, a global positioning point, a location triangulation, a location coordination, or other location. The conclusion of the first time period is at an end of a lapse of time designated by the first time period.

At decision diamond 130, the sound detection system determines whether the vehicle has changed locations by comparing the first and second location statuses. According to one or more embodiments, the edge device of the sound detection system can perform the operations of block 130. If the first and second location statuses are different, then method 100 proceeds (as shown by arrow 132) to block 135. Different first and second location statuses indicate that the vehicle has changed locations (e.g., the vehicle is moving or being driven). At block 135, the second location status is stored as the first location status of the vehicle. The method 100 returns to block 120. If the first and second location statuses are the same, then method 100 proceeds (as shown by arrow 137) to block 140. The same first and second location statuses indicate that the vehicle is in a static position (e.g., a traffic stop is in progress).

At block 140, the sound detection system enables a transducer to listen and record audio surrounding the vehicle (e.g., moved or driven away from the traffic stop). A transducer is an electronic device that detects and converts environmental conditions into electrical signals that can be processed by the edge device. Examples of the transducer include a microphone, but are not limited thereto. According to one or more embodiments, the edge device is electrically coupled to the microphone of the sound detection system that can perform the operations of block 140.

At decision diamond 150, the sound detection system determines whether a target sound is heard by analyzing the audio. The target sound can be any distinguishable sound, noise, or clamor. By way of example, the target sound can be the sound of a firearm discharge. According to one or more embodiments, the sound detection system is configured to analyze the audio to identify the firearm discharge by listening for types of decibel levels and echoes inside the audio that track to the firearm discharge. The sound detection system is configured to analyze the audio to further detect a range of distances within which the target sound occurred. For example, a range of distances can include, but is not limited to zero (0) meters (0 feet) to 7.6meters (25 feet), zero (0) meters (0 feet) to 15.2 meters (50 feet), 7.6 meters (25 feet) to 15.2meters (50 feet), zero (0) meters (0 feet) to 30.48 meters (100), and 15.2 meters (50 feet) to 30.48meters (100).

If the target sound (e.g., the firearm discharge) is not detected, then method 100 loops (as shown by arrow 152) through the decision diamond 150 to continuously listen, record, and analyze the audio. During to the loop (as shown by arrow 152) of the method 100 through the block 140 and the decision diamond 150, the sound detection system confirms that the vehicle is in the static position via a sub-method 153. According to one or more embodiments, the edge device of the sound detection system can perform the loop (e.g., the blocks 140 and 150 and the arrow 152) and/or the sub-method 153.

By way of example, at block 154, the sound detection system waits for a second time period. The second time period beginning at the conclusion of the first time period. The conclusion of the second time period is at an end of a lapse of time designated by the second time period. The second time period is a configurable amount of time. The second time period can be configured to be the same as the first time period. The second time period can be configured to be different from the first time period. Examples of the first time period include, but are not limited to five (5) seconds, ten (10) seconds, 15 seconds, 30 seconds, and 60 seconds. Other examples of the first time period include, but are not limited to, a value selected from a range of one (1) second to 3,600 seconds.

At block 155, the sound detection system detects a third location status at the conclusion of the second time period. The third location status can be a location designated by, for example, a longitude and latitude, a global positioning point, a location triangulation, a location coordination, or other location. At decision diamond 156, the sound detection system determines whether the vehicle has changed locations from the static position by comparing the third location status against the first location status.

If the first and third location statuses are the same, then method 100 remains in the loop (as shown by arrow 157). The same first and third location statuses indicate that the vehicle is in the static position (e.g., the traffic stop is in progress).

If the first and third location statuses are different, then method 100 proceeds to exit (as shown by arrow 158) to block 159. Different first and third location statuses indicate that the vehicle has changed locations (e.g., the vehicle is moving or being driven away from the traffic stop). At block 159, the third location status is stored as the first location status of the vehicle. The sound detection system exits the sub-method 154, and the method 100 returns to block 120.

Returning to decision diamond 150, the sound detection system determines whether the target sound is heard by analyzing the audio. If the target sound (e.g., the firearm discharge) is detected, then method 100 proceed (as shown by arrow 165) to block 168.

At block 168, the sound detection system sends an alert. The alert include can include a package of information. The package of information can include, but is not limited to, one or more of a data package, a signal, a message, a sound recording, a sound clip, a location, and other information. According to one or more embodiments, the sound detection system can send the alert to a web application of the sound detection system. According to one or more embodiments, the edge device of the sound detection system can perform the operations of block 168.

At block 170, the sound detection system sends the alert to a mobile device. The mobile device can include any device in possession of the user (e.g., a police officer, a driver of the vehicle, and/or emergency service personnel). The mobile device includes a memory with computer program code (e.g., a mobile application) stored thereon for causing the edge device to perform operations of method 100. The mobile device can include, but is not limited to, a smart phone, a cell phone, a tablet computer, a personal computer, or other device. According to one or more embodiments, the edge device or the web application of the sound detection system can perform the operations of block 170.

At block 172, the mobile device generates prompt. The prompt can be one or more user interfaces elements that include any pop-up, notification, sound, or combination thereof that draws attention of the user to the mobile device. The one or more user interface elements can include a confirmation element (e.g., a selectable icon on a screen of the mobile device) that can be selected by the user. The one or more user interface elements can include instructions to tap an external button (e.g., a volume button) on the mobile device that can be pressed by the user. At block 174, the mobile device receives a user input. The user input can be a selection of the confirmation element or a tapping of the external button. At block 176, the mobile device sends a cancelation notice upon receipt of the user input. If the user input is not received, then this branch of the method 100 ends while the method 100 continues at block 180. For example, when the sound detection system detects the target sound, the user can select the confirmation element to cancel the alert (e.g., in a case where the target sound detected sounded like but was not a firearm discharge).

At block 180, the sound detection system sends the alert to an external system. According to one or more embodiments, the edge device or the web application of the sound detection system can perform the operations of block 180. Examples of external systems include, but are not limited to, dispatch systems, emergency systems, and medical systems. an web application (alert includes package information).

At block 181, the sound detection system receives the cancelation notice. According to one or more embodiments, the edge device or the web application of the sound detection system can receive the cancelation notice from the mobile device.

At block 190, the alert by the sound detection system to the external system cause an immediate order of emergency service and/or dispatch of additional resources. Note that, at arrow 195, the web application or the edge device forward the cancelation notice to the external systems to cancel the immediate order of emergency service and/or dispatch of additional resources. One or more advantages, technical effects, and/or benefits of the software platform and interface operating the method 100 include, but are not limited to, guaranteeing the safety of a user (e.g., a police office) when a vehicle is stopped (e.g., during a traffic stop) with respect to gun violence (e.g., identified by the target sound).

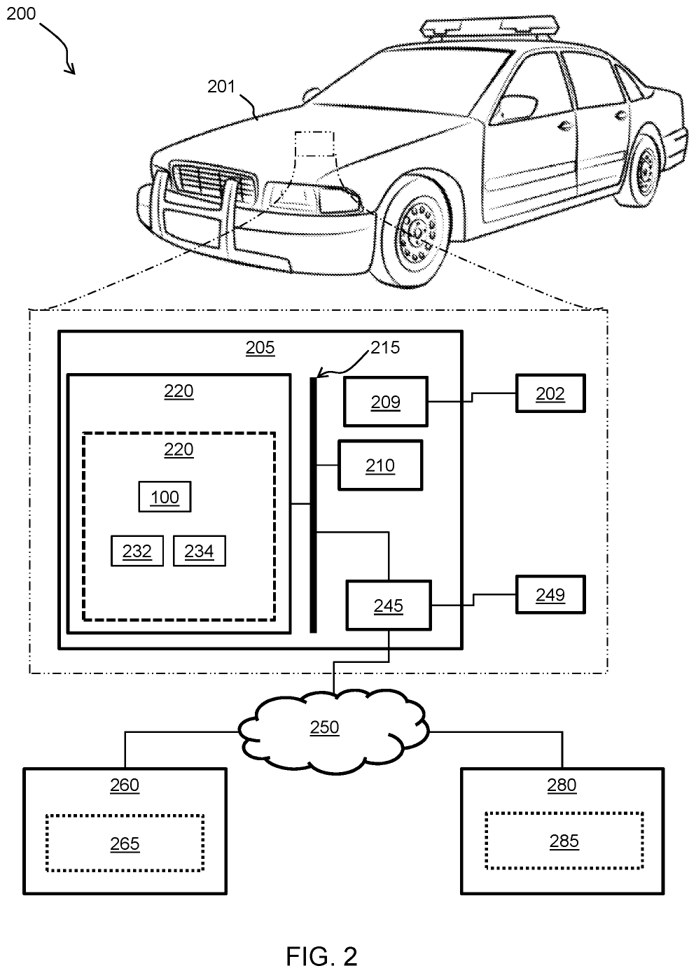

Turning now to FIG. 2, a computing system 200 is illustrated according to one or more embodiments. The computing system 200 can be representative of one or more computing devices, one or more computing apparatuses, and/or computing environments, which can include hardware, software, or a combination thereof. Further, embodiments of the computing system 200 disclosed may include apparatuses, systems, methods, and/or computer program products at any possible technical detail level of integration. Thus, the computing system 200 and elements therein may be adapted or configured to perform as an online platform, a server, an embedded computing system, a personal computer, a console, a personal digital assistant (PDA), a cell phone, a tablet computing device, a quantum computing device, cloud computing device, a mobile device, a smartphone, a fixed mobile device, a smart display, a wearable computer, a combination thereof, or another configuration. The computing system 200 can implement a combination of multiple processes to ensure any sense of accuracy. By way of example, the computing system 200 is representative of the sound detection system and the traffic stop firearm discharge detection system. Further, the computing system 200 can operate to alert a dispatch when there is a gunshot during a traffic stop and automatically call for backup/ambulance (if no false alert response is received).

The computing system 200 includes a vehicle 201 including a power source 202 (e.g., a car battery), an edge device 205, an inverter 209 a processor 210, a system bus 215, a system memory 220 including software 230 (e.g., further including a location module 232 and configurable settings 234), an adapter 245, input/output devices (e.g., represented by a microphone 249), a network 250, a mobile device 260 including software (e.g., a mobile application 265), and a server 280 including software (e.g., a web application 285).

The vehicle 201 can be any municipal vehicle, police vehicle, farm vehicle, recreational vehicle, sport utility vehicle, consumer vehicle, commercial vehicle, water vehicle, air vehicle, or other vehicle. Vehicle 201 includes the power source 202 (e.g., the car battery) that provides power to electronics of the vehicle 201 and the edge device. Car batteries, generally, provide alternating current power. In other cases, car batteries provide direct current power. By way of example, the electronics of the vehicle 201 can include a communications system (e.g., a police vehicle connection) that can receive the power from the power source 202 and can be used by the edge device 205 to send alerts.

According to one or more embodiments, the edge device 205 is an embedded computing system or device that includes the inverter 209, the processor 210, the system bus 215, the system memory 220, and the adapter 245. According to one or more embodiments, edge device 205 is configured to receive the power from the power source 202. For example, the inverter 209 is configured to convert the alternating current power of the power source 202 into direct current power. The edge device 205 can further include the microphone 249 or include a mechanism or port for connecting to the microphone 249. The microphone 249 is an example of a transducer that detects and converts environmental conditions (e.g., audio external to the vehicle 201) into electrical signals that can be processed by the edge device 205. The edge device 205 can include other electronic components (e.g., one or more accelerometers).

The edge device 205 can include one or more central processing units (CPU(s)), which are collectively or generically referred to as the processor 210. The processor 210, also referred to as processing circuits, is coupled via the system bus 215 to the system memory 220 and various other components.

The processor 210 may be any type of general or specific purpose processor, including a central processing unit (CPU), application specific integrated circuit (ASIC), field programmable gate array (FPGA), graphics processing unit (GPU), controller, multi-core processing unit, three-dimensional processor, quantum computing device, or any combination thereof. The processor 210 may also have multiple processing cores, and at least some of the cores may be configured to perform specific functions. Multi-parallel processing may also be configured.

The bus 215 (or other communication mechanism) is configured for communicating information or data to the processor 210, the system memory 220, and various other components, for example, the adapter 245.

The system memory 220 is an example of a (non-transitory) computer readable storage medium, where the software 230 (i.e., the software platform and interface described herein) can be stored as software components, modules, engines, instructions, or other software for execution by the processor 210 to cause the edge device 205 and/or the computing system 200 to operate (e.g., as described herein with reference to FIGS. 1 and 3-5). The system memory 220 can include any combination of a read only memory (ROM), a random access memory (RAM), internal or external Flash memory, embedded static-RAM (SRAM), solid-state memory, cache, static storage (e.g., a magnetic or optical disk), or any other types of volatile or non-volatile memory. Non-transitory computer readable storage mediums may be any media that can be accessed by the processor 210 and may include volatile media, non-volatile media, or of other media. For example, the ROM is coupled to the system bus 215 and may include a basic input/output system (BIOS), which controls certain basic functions of edge device 205, and the RAM is read-write memory coupled to the system bus 215 for use by the processors 210. Non-transitory computer readable storage mediums can include any media that is removable, non-removable, or other mediums.

With respect to adapter 245 of FIG. 2, edge device 205 can particularly include an input/output (I/O) adapter, a device adapter, and/or a communications adapter. According to one or more embodiments, the I/O adapter can be configured as a small computer system interface (SCSI), of in view of frequency division multiple access (FDMA) single carrier FDMA (SC-FDMA), time division multiple access (TDMA), code division multiple access (CDMA), orthogonal frequency-division multiplexing (OFDM), orthogonal frequency-division multiple access (OFDMA), global system for mobile (GSM) communications, general packet radio service (GPRS), universal mobile telecommunications system (UMTS), cdma2000, wideband CDMA (W-CDMA), high-speed downlink packet access (HSDPA), high-speed uplink packet access (HSUPA), high-speed packet access (HSPA), long term evolution (LTE), LTE Advanced (LTE-A), 802.11x, Wi-Fi, Zigbee, Ultra-WideBand (UWB), 802.16x, 802.15, home Node-B (HnB), Bluetooth, radio frequency identification (RFID), infrared data association (IrDA), near-field communications (NFC), fifth generation (5G), new radio (NR), or any other wireless or wired device/transceiver for communication. For example, the I/O adapter can couple to a communication system (e.g., a police vehicle connection) of vehicle 201 to send and receive communication from the other elements of the computing system 200 (e.g., to send alerts). The device adapter interconnects input/output devices (e.g., a microphone 249, a display, a keyboard, a control device, a camera, a speaker, or other device) to the system bus 215. The display can be configured to provide one or more UIs or graphic UIs (GUIs) that can be captured by and analyzed by software 230, as the users interact with the edge device 205. Examples of the display can include, but are not limited to, a plasma, a liquid crystal display (LCD), a light emitting diode (LED), a field emission display (FED), an organic light emitting diode (OLED) display, a flexible OLED display, a flexible substrate display, a projection display, a 4K display, a high definition (HD) display, a Retina@ display, an in-plane switching (IPS) display or other displays. The display may be configured as a touch, three-dimensional (3D) touch, multi-input touch, or multi-touch display using resistive, capacitive, surface-acoustic wave (SAW) capacitive, infrared, optical imaging, dispersive signal technology, acoustic pulse recognition, frustrated total internal reflection, or other mechanism as understood by one of ordinary skill in the art for input/output (I/O). The keyboard and the control device (e.g., a computer mouse, a touchpad, a touch screen, a keypad, or other mechanism) may be further coupled to the system bus 215 for input to the edge device 205. In addition, one or more inputs may be provided to the computing system 200 remotely via another computing system in communication therewith, or the edge device 205 may operate autonomously.

According to one or more embodiments, the software 230 can be configured in hardware, software, or a hybrid implementation. The software 230 can be composed of modules and/or models that are in operative communication with one another, and to pass information or instructions. The software 230 of FIG. 2 can also be representative of an operating system, a client application, and/or other software for the edge device 205 for the computing system 200. The software 230 operates the location model 232 to detect one or more location status, one or more static positions, and/or one or more moving positions. The software 230 stores and operates the configurable settings 234. The configurable settings 234 can include, but are not limited to, one or more time periods, one or more alert types, one or more false alarm settings, one or more ranges/distances, one or more target sounds, one or more decibel levels, one or more echoes, and other settings. The software 230 can be configured to interact with one or more mobile devices 260 and in cooperation with a plurality of edge devices 205. For instance, if multiple police officers and police vehicles are at a traffic stop, the computing system 200 can collectively operate across all devices present at the traffic stop to analyze multiple audio recordings and provide prospective alerts. In this regard, the computing system 200 can be an intelligent system.

According to one or more embodiments, the intelligent system can include machine learning and artificial intelligence to analyze multiple audio recordings and provide prospective alerts.

The mobile device 260 can be a personal digital assistant (PDA), a cell phone, a tablet computing device, a mobile device, a smartphone, a fixed mobile device, a wearable computer, or other computing device that stores an implements the mobile application 265. According to one or more embodiments, the mobile application 265 can be configured in hardware, software, or a hybrid implementation. The mobile application 265 can be composed of modules and/or models that are in operative communication with one another, and to pass information or instructions. The mobile application 265 can also be representative of an operating system, a mobile application, a client application, and/or other software for the computing system 200. According to one or more embodiments, the mobile application 265 operates to mitigate false alerts by the edge device 205. By way of example, the mobile application 265 is installed on a police phone to provide a police officer an ability to actively claim a false alert.

The server 280 can be an online platform, a server, a personal computer, a console, a quantum computing device, cloud computing device, or other computing device that stores and implements the web application 285. According to one or more embodiments, the web application 285 can be configured in hardware, software, or a hybrid implementation. The web application 285 can be composed of modules and/or models that are in operative communication with one another, and to pass information or instructions. The web application 285 can also be representative of an operating system, a web application, a server application, and/or other software for the computing system 200. According to one or more embodiments, the web application 285 operates to cause instantaneous or near instantaneous alerts to an external system (e.g., a dispatcher system). Note that instantaneous or near instantaneous are terms that refer to close in time or rapid communication, for example within a few seconds. Conventionally, a dispatcher may take up to 5 minutes to dispatch emergency medical services after a firearm is discharged due to delayed communication and incomplete information. In contrast, the web application 285 can provide the instantaneous or near instantaneous alerts (e.g., one (1) to five (5) seconds after firearm discharge detection) and dispatch resources, thereby reducing the response time to a firearm discharge to a few seconds.

According to one or more embodiments, the software 230, the mobile application 265, and/or the web application 285 can provide one or more user interfaces as needed. The user interfaces include, but are not limited to, graphic user interfaces, window interfaces, internet browsers, and/or other visual interfaces for applications, operating systems, file folders, and other software. Thus, user input can include any interaction or manipulation of the user interfaces provided by software 230. The software 230 can further include custom modules to perform application specific processes or derivatives thereof so that the computing system 200 may include additional functionality. For example, according to one or more embodiments, the software 230, the mobile application 265, and/or the web application 285 may be configured to store information, instructions, commands, or data to be executed or processed by at least the processor 210 to logically implement the method 100 of FIG. 1.

Further, modules and/or models of the software 230 can be implemented as a hardware circuit comprising custom very large-scale integration (VLSI) circuits or gate arrays, off-the-shelf semiconductors (e.g., logic chips, transistors, or other discrete components), in programmable hardware devices (e.g., field programmable gate arrays, programmable array logic, programmable logic devices), graphics processing units, or other hardware. Modules and/or models of the software 230 can be at least partially implemented in software for execution by various types of processors. According to one or more embodiments, an identified unit of executable code may include one or more physical or logical blocks of computer instructions that may, for instance, be organized as an object, procedure, routine, subroutine, or function. Executables of an identified module co-located or stored in different locations so that, when joined logically together, comprise the module. A module of executable code may be a single instruction, one or more data structures, one or more data sets, a plurality of instructions, or other instructions distributed over several different code segments, among different programs, across several memory devices, or other configurations. Operational or functional data may be identified and illustrated herein within modules of software 230, and may be embodied in a suitable form and organized within any suitable type of data structure.

Furthermore, modules and/or models of the software 230 can also include, but are not limited to, the location modules 232 and machine learning and/or an artificial intelligence (ML/AI) algorithm modules. The location module 232 can be configured to create, build, store, and provide algorithms and models that determine a location of the edge device 205 and relative distances to target sounds. According to more or more embodiments, the location module 232 can implement location, geosocial networking, spatial navigation, satellite orientation, surveying, distance, direction, and/or time software.

The communications adapter interconnects the system bus 215 with a network 250, which may be an outside network, enabling the edge device 205 to communicate data with other such devices through the network 250 (e.g., the mobile device 260 and the server 280). In one embodiment, adapter 245 may be connected to one or more I/O buses that are connected to the system bus 215 via an intermediate bus bridge. Suitable I/O buses for connecting peripheral devices (e.g., hard disk controllers, network adapters, and graphics adapters) typically include common protocols (e.g., the Peripheral Component Interconnect (PCI)).

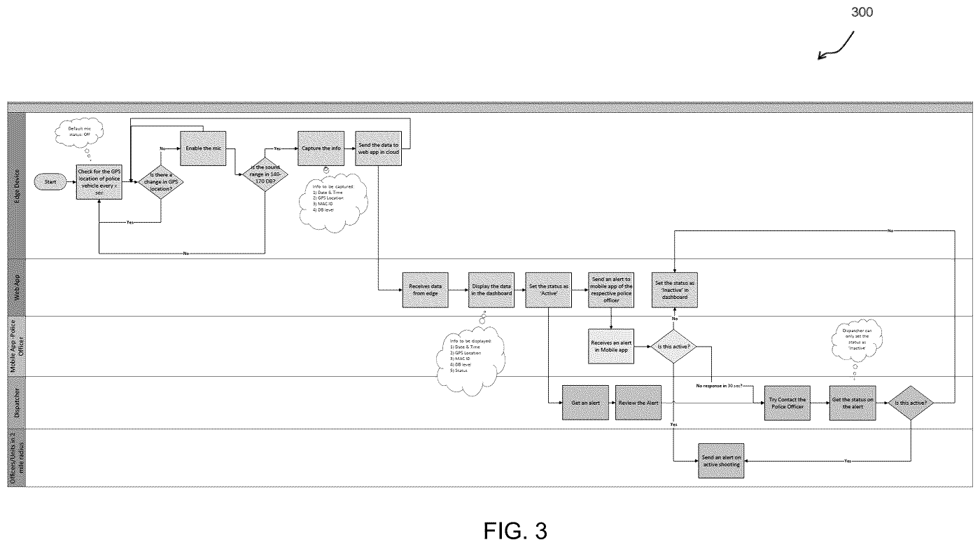

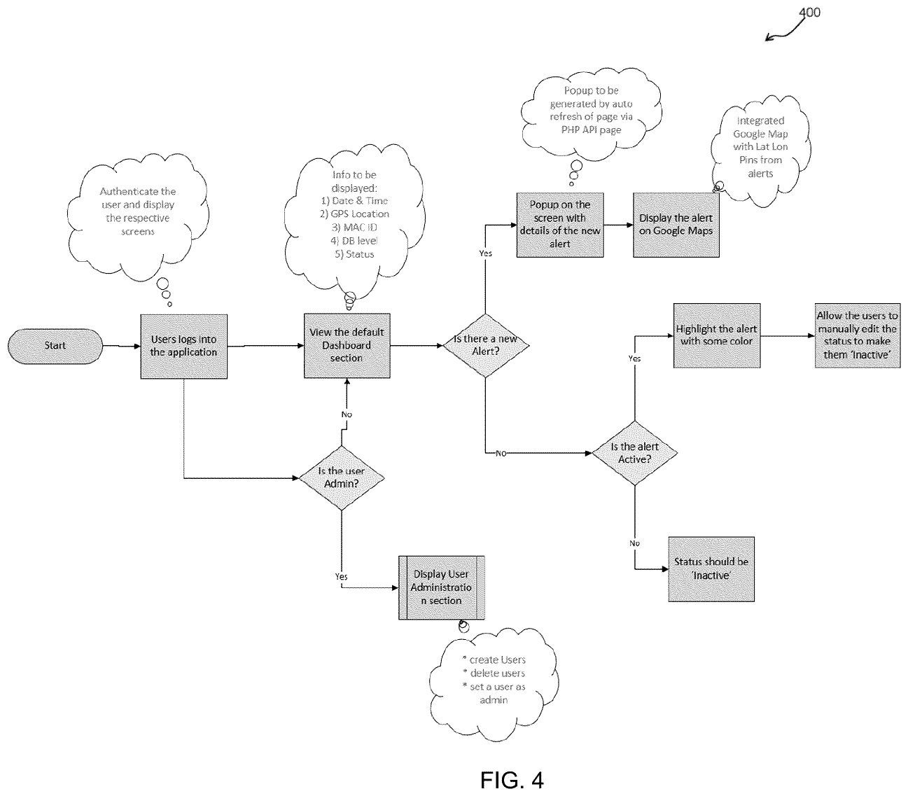

According to one or more embodiments, the functionality of the edge device 205 with respect to the software 230 can also be implemented on the mobile device 260 and the server 280, as represented by separate instance of the mobile application 265 and the web application 285. Note that all data and information of the computing system 200 can be stored in a common repository located at the edge device 205, the mobile device 260, or the server 280 and can be downloaded (on demand) to and/or from each of the edge device 205, the mobile device 260, and the server 280. According to one or more embodiments, the software 230, the mobile application 265, and/or the web application 285 may be configured to store information, instructions, commands, or data to be executed or processed by the computing system 200 to logically implement a method 300 of FIG. 3 and a method 400 of FIG. 4.

The method 300 is an example operation by the computing system 200 according to one or more embodiments.

The method 400 is an example operation set by the web application 285 according to one or more embodiments.

According to one or more embodiments, an edge device is provided. The edge device includes a microphone. The edge device is configured to detect a static position for the edge device for a first time period; record audio received by the microphone while the static position remains constant; determine whether a target sound is within the audio received by the microphone by analyzing audio; and send an alert when the target sound is determined to be within the audio.

According to one or more embodiments of any of the edge devices herein, the target sound can include a firearm discharge.

According to one or more embodiments of any of the edge devices herein, the edge device can analyze the audio for types of decibel levels and echoes inside the audio that track to the firearm discharge.

According to one or more embodiments of any of the edge devices herein, the alert can include a package of information including a location.

According to one or more embodiments of any of the edge devices herein, the alert can cause an immediate order of emergency service or dispatch of additional resources.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. A computer readable medium, as used herein, is not to be construed as being transitory signals per se, for example radio waves or other freely propagating electromagnetic waves, electromagnetic waves propagating through a waveguide or other transmission media (e.g., light pulses passing through a fiber-optic cable), or electrical signals transmitted through a wire

Examples of computer-readable media include electrical signals (transmitted over wired or wireless connections) and computer-readable storage media. Examples of computer-readable storage media include, but are not limited to, a register, cache memory, semiconductor memory devices, magnetic media (e.g., internal hard disks and removable disks), magneto-optical media, optical media (e.g., compact disks (CD) and digital versatile disks (DVDs)), a random access memory (RAM), a read-only memory (ROM), an erasable programmable read-only memory (EPROM or Flash memory), a static random access memory (SRAM), and a memory stick. A processor in association with software may be used to implement a radio frequency transceiver for use in a terminal, base station, or any host computer.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An edge device comprising a microphone, the edge device being configured to:
detect a static position of the edge device for a first time period;
record audio received by the microphone while the static position remains constant;
determine whether a target sound is within the audio received by the microphone by analyzing audio; and
send an alert when the target sound is determined to be within the audio.

2. The edge device of claim 1, wherein the target sound comprises a firearm discharge.

3. The edge device of claim 2, wherein the edge device is configured to analyze the audio for types of decibel levels and echoes inside the audio that track to the firearm discharge.

4. The edge device of claim 1, wherein the alert comprises a package of information including a location.

5. The edge device of claim 1, wherein the alert is configured to cause an immediate order of emergency service or dispatch of additional resources.

6. A method for processing a sound, comprising:
detecting a static position of an electronic network device for a first time period;
recording audio by the electronic network device while the static position remains constant;
analyzing the recorded audio by the electronic network device to determine whether a target sound is within the recorded audio; and
causing the electronic network device to send an alert when the target sound is determined to be within the recorded audio.

7. The method of claim 6, wherein the electronic network device is an edge device.

8. The method of claim 6, further comprising the electronic network device analyzing the recorded audio for types of decibel levels and echoes inside the audio that track to a firearm discharge.

9. The method of claim 6, further comprising the electronic network device sending an alert that includes a package of information including a location.

10. The method of claim 6, further comprising automatically triggering an immediate order of emergency service or dispatch of additional resources in response to the alert sent by the electronic network device.

11. An emergency vehicle comprising an electronic network device including a microphone, the electronic network device being configured to:
detect a static position of the emergency vehicle for a first time period;
record audio received by the microphone while the static position of the emergency vehicle remains constant;
determine whether a target sound is within the audio received by the microphone by analyzing the recorded audio; and
send an alert when the target sound is determined to be within the audio.
